(19) United States
(12) Patent Application Publication
(10) Pub. No.: US 2026/0260469 A1
(43) Pub. Date: Sep. 3, 2026

(54) Method for Generating Training Data for Training a Machine Learning Algorithm

(71) Applicant: Robert Bosch GmbH, Stuttgart (DE)

(72) Inventors: Denis Tananaev, Sindelfingen (DE); Steffen Abraham, Hildesheim (DE); Ze Guo, Berlin (DE)

(21) Appl. No.: 19/158,103

(22) PCT Filed: Feb. 16, 2024
(86) PCT No.: PCT/EP2024/053984

§ 371 Date: Aug. 20, 2025

(30) Foreign Application Priority Data
Feb. 21, 2023 (DE) 10 2023 201 500.5

(51) Int. Cl. G06V 10/774; G06N 20/00; G06T 7/10; G06V 10/74

(52) U.S. Cl. CPC G06V 10/774; G06N 20/00; G06T 7/10; G06V 10/761

(57) ABSTRACT

A method is for generating training data for training a machine learning algorithm. The algorithm determines at least one stixel in image data captured by an optical sensor and, for each of the at least one stixel, a respective distance to an object represented in the at least one stixel from the captured image data. The method further includes ascertaining a distance to the object represented in the corresponding stixel based on the image data and information detected using the at least one distance sensor. Ascertaining a distance includes a respective process of transforming coordinates in a coordinate system which represents one of the at least one distance sensors into coordinates in a coordinate system which represents a base plane.

The invention relates to a method for generating training data for training a machine learning algorithm and, more particularly, to an improved method for generating training data for training a machine learning algorithm. This algorithm is designed to determine at least one stixel in image data captured by an optical sensor and, for each of the at least one stixel, a distance to an object represented in the at least one stixel from the captured image data.

Machine-learning algorithms are based on using statistical methods to train a data processing system such that it may perform a specific task without having been explicitly programmed to do so. The goal of machine learning is to construct algorithms that may learn and make predictions from data. These algorithms create mathematical models with which data may be classified, for example.

Training of a machine learning algorithm is usually based on training data, for example through a deep learning process, wherein the training data is labeled or provided with corresponding information that reflects the actual behavior or circumstances of a present application, for which the machine learning algorithm is trained, that is, a system or a corresponding downstream process to be modeled.

Such machine learning algorithms are used, for example, in controlling driver assistance systems of a motor vehicle and/or functions of an autonomously driving motor vehicle. A corresponding machine learning algorithm may be designed to detect objects or obstacles, such as other motor vehicles and/or pedestrians, in image data captured by an optical sensor of a motor vehicle. The driver assistance system and/or the function of the autonomously driving motor vehicle can then be controlled based on the detected objects of the motor vehicle to avoid safety-critical situations when using or operating the motor vehicle.

Machine learning algorithms are also known, which are designed or trained based on correspondingly labeled training data, to determine at least one stixel in image data captured by an optical sensor of a motor vehicle and the respective distance to an object represented in the at least one stixel from the image data. Advantageously, this method does not require a corresponding distance sensor, such as a lidar sensor, to determine the distance to the at least one stixel and the machine learning algorithm can also be used in motor vehicles equipped with only a camera and no corresponding distance sensor.

A stixel is a superpixel representation of depth information in an image or image data in the form of a vertical stick or rod, which approximates the closest obstacles within a particular vertical portion of the scene.

However, a disadvantage is that frequently only little training data is available for training a machine learning algorithm that is designed to determine at least one stixel in image data captured by an optical sensor of a motor vehicle and the respective distance to an object represented in the at least one stixel from the image data, and known methods for creating additional training data for training a machine learning algorithm, said machine learning algorithm being designed to determine at least one stixel in image data captured by an optical sensor of a motor vehicle and the respective distance to an object represented in the at least one stixel from the image data, which are based on morphological operations, for example, are frequently prone to errors.

DE 10 2019 200 147.5 discloses a method for providing ground truth data, wherein GPS data recorded during a trip is provided, the GPS data is displayed along with paths of travel, and corresponding ground truth data is generated from the GPS data by selecting the GPS data along with the respective path of travel.

The invention thus solves the task of providing a method for generating training data for training a machine learning algorithm, said algorithm being designed to determine at least one stixel in image data captured by an optical sensor and, for each of the at least one stixel, the respective distance to an object represented in the at least one stixel from the captured image data.

The task is solved with a method for generating training data for training a machine learning algorithm, said algorithm being designed to determine at least one stixel in image data captured by an optical sensor and, for each of the at least one stixel, the respective distance to an object represented in the at least one stixel from the captured image data according to the features of claim 1.

The task is additionally solved with a system for generating training data for training a machine learning algorithm, said algorithm being designed to determine at least one stixel in image data captured by an optical sensor and, for each of the at least one stixel, the respective distance to an object represented in the at least one stixel from the captured image data according to the features of claim 8.

### Disclosure of the Invention

According to one embodiment of the invention, this task is solved with a method for generating training data for training a machine learning algorithm, which is designed to determine at least one stixel in image data captured by an optical sensor and, for each of the at least one stixel, a distance to an object represented in the at least one stixel from the captured image data, wherein the method comprises the generation of image data about the surroundings of a motor vehicle, wherein the image data is based on information detected by at least one optical sensor, wherein the at least one optical sensor comprises at least one distance sensor, the ascertainment of objects represented in the image data, the generation of at least one stixel from the image data based on the ascertained objects, and, for each of the at least one stixel, the ascertainment of a distance to the object represented in the corresponding stixel based on the image data and information detected by the at least one distance sensor, wherein ascertaining a distance includes a respective process of transforming coordinates in a coordinate system which represents one of the at least one distance sensors into coordinates in a coordinate system which represents a base plane.

The generation of image data, for example, image data about the surroundings of a motor vehicle, means that the image data is directly captured by a corresponding sensor, such as a camera attached to the motor vehicle, or that data captured by other optical sensors of the motor vehicle, particularly a lidar sensor, is converted into image data.

Image data further refers to data which can be reproduced as an image or graphic with the help of a special program.

A sensor, which is also referred to as a detector, (measurand or measurement) transducer or (measurement) probe, is furthermore a technical component that may acquire certain physical or chemical properties and/or the material properties of its environment either qualitatively or quantitatively as a measurand.

An optical sensor is understood to be a sensor that can detect objects using light or comparable radiation. Distance sensors are sensors that measure the distance between the sensor and an object. An example of such a distance sensor is a lidar sensor, which can detect objects based on radiation reflected or scattered back from the objects using laser radiation. Lidar sensors are used for distance measurement, among other things, where distances can be determined based on the principle of light travel time measurement from the backscattered radiation.

A coordinate system representing a distance sensor is additionally understood to be a coordinate system whose origin coincides with the location of the distance sensor, and which defines the position and orientation of the distance sensor.

A coordinate system representing the base plane or a coordinate system of the base plane is further understood to be a world coordinate system whose origin lies on the base plane or ground and from which the coordinates of points lying on the base plane can be obtained.

Coordinate transformations or transformations of coordinates are further understood to mean conversions or changes of coordinate values when switching from one coordinate system to another.

Thus, a large number of stixels with corresponding distance information, or training data for training the machine learning algorithm, can be generated through relatively simple image processing operations and coordinate transformations, without the need for complex and resource-intensive adjustments or operations. Additionally, the method can be implemented using relatively simple sensors that are already installed in conventional motor vehicles.

Furthermore, the method, which is based on coordinate transformation of actually acquired data, is comparatively less prone to errors. In particular, coordinate transformations are applied when a problem is more easily solved in another coordinate system, whereby the corresponding distance value in the world coordinate system representing the base plane can be read or easily derived from the corresponding coordinates, for example, based on known norms.

Overall, this is thus an improved method for generating training data for training a machine learning algorithm, said algorithm being designed to determine at least one stixel in image data captured by an optical sensor and, for each of the at least one stixel, the respective distance to an object represented in the at least one stixel from the captured image data.

In one embodiment, the at least one optical sensor further comprises a camera, wherein the image data is image data captured by the camera, and wherein the step of generating at least one stixel comprises generating a segmentation of the image data.

Segmentation is understood to mean the division of image data into individual columns or content-related contiguous regions.

This has the advantage that even if there are no or only a few data points captured by the at least one distance sensor, sufficient training data can be generated reliably and accurately to generate the image data.

The step of generating a segmentation of the image data may comprise applying a machine learning algorithm trained to segment image data. As a result, the step of generating a segmentation can be automated and made less prone to errors.

However, the fact that the step of generating a segmentation of the image data comprises applying a machine learning algorithm trained to segment image data is only one possible embodiment. Rather, the segmentation may also be generated, for example, by employing other image processing algorithms suitable for creating a segmentation.

Furthermore, the information detected by the at least one distance sensor may comprise, for each of the at least one stixel, information about at least one point on the object represented in the corresponding stixel, on which beams transmitted by the at least one distance sensor are reflected. This has the advantage that the distance to the corresponding stixel can be ascertained directly without the need for further conversions, thereby also conserving resources.

In particular, the information detected by the at least one distance sensor may comprise information about a point on the object represented in the corresponding stixel, on which beams transmitted by the at least one distance sensor are reflected, and which has at least one predetermined height compared to the base surface.

The fact that a point has at least one predetermined height relative to the base plane means that the corresponding point, along a normal or orthogonal line running through the point, has a corresponding distance to an intersection point between the normal line and the base plane.

This ensures that the coordinates of the corresponding point in the coordinate system representing the at least one distance sensor can be reliably and easily transformed into coordinates in the coordinate system representing the base plane.

A further embodiment of the invention specifies a method for training a machine learning algorithm which is designed to determine at least one stixel in image data captured by an optical sensor and, for each of the at least one stixel, the respective distance to an object represented in the at least one stixel from the captured image data, wherein the method comprises a generation of training data for training the machine learning algorithm, wherein the training data was generated by a method described above for generating training data for training a machine learning algorithm, said machine learning algorithm being designed to determine at least one stixel in image data captured by an optical sensor and, for each of the at least one stixel, the respective distance to an object represented in the at least one stixel from the captured image data, and training of the machine learning algorithm based on the generated training data.

Thus, a method is indicated for training a machine learning algorithm that is designed to determine at least one stixel in image data captured by an optical sensor and, for each of the at least one stixel, the respective distance to an object represented in the at least one stixel from the captured image data, which is based on training data generated by an improved method for generating training data for training a machine learning algorithm, said machine learning algorithm being designed to determine at least one stixel in image data captured by an optical sensor and, for each of the at least one stixel, the respective distance to an object represented in the at least one stixel from the captured image data. In particular, a large number of stixels with corresponding distance information, or training data for training the machine learning algorithm, can be generated through relatively simple image processing operations and coordinate transformations, without the need for complex and resource-intensive adjustments or operations. Additionally, the method can be implemented using relatively simple sensors that are already installed in conventional motor vehicles. Furthermore, the method of generating training data, which is based on a coordinate transformation of actually acquired data, is comparatively less prone to errors. In particular, coordinate transformations are applied when a problem is more easily solved in another coordinate system, whereby the corresponding distance value in the world coordinate system representing the base plane can be read or easily derived from the corresponding coordinates, for example, based on known norms.

In another embodiment, a method is specified for controlling a controllable system by a machine learning algorithm which is designed to determine at least one stixel in image data captured by an optical sensor and, for each of the at least one stixel, the respective distance to an object represented in the at least one stixel from the captured image data, wherein the method comprises a provision of a machine learning algorithm for controlling the controllable system, wherein the machine learning algorithm is designed to determine at least one stixel in image data captured by an optical sensor and, for each of the at least one stixel, the respective distance to an object represented in the at least one stixel from the captured image data, and wherein the machine learning algorithm was trained by a method described above for training a machine learning algorithm, said machine learning algorithm being designed to determine at least one stixel in image data captured by an optical sensor and, for each of the at least one stixel, the respective distance to an object represented in the at least one stixel from the captured image data, and controlling of the controllable system based on the provided machine learning algorithm.

A controllable system is understood here to be a robotic system, for example a driver assistance system of a motor vehicle or function of an autonomously driving motor vehicle.

Thus, a method is indicated for controlling a controllable system based on a machine learning algorithm that is designed to determine at least one stixel in image data captured by an optical sensor and, for each of the at least one stixel, the respective distance to an object represented in the at least one stixel from the captured image data, wherein the machine learning algorithm was trained based on training data generated by an improved method for generating training data for training a machine learning algorithm, said machine learning algorithm being designed to determine at least one stixel in image data captured by an optical sensor and the respective distance to the at least one stixel from the captured image data. In particular, a large number of stixels with corresponding distance information, or training data for training the machine learning algorithm, can be generated through relatively simple image processing operations and coordinate transformations, without the need for complex and resource-intensive adjustments or operations. Additionally, the method can be implemented using relatively simple sensors that are already installed in conventional motor vehicles. Furthermore, the method of generating training data, which is based on a coordinate transformation of actually acquired data, is comparatively less prone to errors. In particular, coordinate transformations are applied when a problem is more easily solved in another coordinate system, whereby the corresponding distance value in the world coordinate system representing the base plane can be read or easily derived from the corresponding coordinates, for example, based on known norms.

In another embodiment of the invention, a system is additionally specified for generating training data for training a machine learning algorithm, which is designed to determine at least one stixel in image data captured by an optical sensor and, for each of the at least one stixel, a distance to an object represented in the at least one stixel from the captured image data, wherein the system comprises a first generation unit, which is designed to generate image data, wherein the image data is based on information detected by at least one optical sensor, wherein the at least one optical sensor comprises at least one distance sensor, and wherein the system further comprises a first ascertainment unit, which is designed to ascertain objects represented in the image data, a second generation unit, which is designed to generate at least one stixel from the image data based on the ascertained objects, and a second ascertainment unit, which is designed to ascertain, for each of the at least one stixel, a distance to the object represented in the corresponding stixel based on the image data and information detected by the at least one distance sensor, wherein ascertaining a distance includes a respective process of transforming coordinates in a coordinate system which represents one of the at least one distance sensors into coordinates in a coordinate system which represents a base plane, and wherein the training data is based on the respective image data, a stixel generated therein, and the distance to the object represented by the corresponding stixel.

Thus, this specifies an improved method for generating training data for training a machine learning algorithm, said algorithm being designed to determine at least one stixel in image data captured by an optical sensor and, for each of the at least one stixel, the respective distance to an object represented in the at least one stixel from the captured image data. A large number of stixels with corresponding distance information, or training data for training the machine learning algorithm, can be generated through relatively simple image processing operations and coordinate transformations, without the need for complex and resource-intensive adjustments or operations. In addition, the method can be realized with relatively simple sensors already installed in conventional motor vehicles. In addition, the generation of training data by the system, which is based on a coordinate transformation of actually acquired data, is comparatively less prone to errors. In particular, coordinate transformations are applied when a problem is more easily solved in another coordinate system, whereby the corresponding distance value in the world coordinate system representing the base plane can be read or easily derived from the corresponding coordinates, for example, based on known norms.

In one embodiment, the at least one optical sensor further comprises a camera, wherein the image data is image data captured by the camera, and wherein the first generation unit is designed to generate segmentation of the image data. This has the advantage that even if there are no or only a few data points captured by the at least one distance sensor, sufficient training data can be generated reliably and accurately to generate the image data.

The first generation unit can be designed to apply a machine learning algorithm trained to segment image data, in order to segment the image data. This can automate the generation of a segmentation and make it less prone to errors.

However, the first generation unit being designed to apply a machine learning algorithm trained to segment image data is only one possible embodiment. Rather, the first generation unit may also be designed to apply other image processing algorithms suitable for generating a segmentation.

Furthermore, the information detected by the at least one distance sensor may comprise, for each of the at least one stixel, information about at least one point on the object represented in the corresponding stixel, on which beams transmitted by the lidar sensor are reflected. This has the advantage that the distance to the corresponding stixel can be ascertained directly without the need for further conversions, thereby also conserving resources.

In particular, the information detected by the at least one distance sensor may comprise information about a point on the object represented in the corresponding stixel, on which beams transmitted by the at least one distance sensor are reflected, and which has at least one predetermined height compared to the base surface. This ensures that the coordinates of the corresponding point in the coordinate system representing the at least one optical sensor can be reliably and easily transformed into coordinates in the coordinate system representing the base plane.

In another embodiment of the invention, a system is additionally specified for training a machine learning algorithm which is designed to determine at least one stixel in image data captured by an optical sensor and, for each of the at least one stixel, the respective distance to an object represented in the at least one stixel from the captured image data, wherein the system comprises a supply unit, which is designed to provide training data for training the machine learning algorithm, wherein the training data was generated by a system described above for generating training data for training a machine learning algorithm, said machine learning algorithm being designed to determine at least one stixel in image data captured by an optical sensor and, for each of the at least one stixel, the respective distance to an object represented in the at least one stixel from the captured image data, and a training unit, which is designed to train the machine learning algorithm based on the provided training data.

Thus, a system is indicated for training a machine learning algorithm that is designed to determine at least one stixel in image data captured by an optical sensor and, for each of the at least one stixel, the respective distance to an object represented in the at least one stixel from the captured image data, which is based on training data generated by an improved system for generating training data for training a machine learning algorithm, said machine learning algorithm being designed to determine at least one stixel in image data captured by an optical sensor and, for each of the at least one stixel, the respective distance to an object represented in the at least one stixel from the captured image data. In particular, a large number of stixels with corresponding distance information, or training data for training the machine learning algorithm, can be generated through relatively simple image processing operations and coordinate transformations, without the need for complex and resource-intensive adjustments or operations. In addition, the method can be realized with relatively simple sensors already installed in conventional motor vehicles. In addition, the generation of training data by the system for generating training data, which is based on a coordinate transformation of actually acquired data, is comparatively less prone to errors. In particular, coordinate transformations are applied when a problem is more easily solved in another coordinate system, whereby the corresponding distance value in the world coordinate system representing the base plane can be read or easily derived from the corresponding coordinates, for example, based on known norms.

In another embodiment of the invention, a system is further specified for controlling a controllable system based on a machine learning algorithm which is designed to determine at least one stixel in image data captured by an optical sensor and, for each of the at least one stixel, the respective distance to an object represented in the at least one stixel from the captured image data, wherein the system comprises a supply unit, which is designed to provide a machine learning algorithm for controlling the controllable system, wherein the machine learning algorithm is designed to determine at least one stixel in image data captured by an optical sensor and, for each of the at least one stixel, the respective distance to an object represented in the at least one stixel from the captured image data, and wherein the machine learning algorithm was trained by a method described above for training a machine learning algorithm, said machine learning algorithm being designed to determine at least one stixel in image data captured by an optical sensor and, for each of the at least one stixel, the respective distance to an object represented in the at least one stixel from the captured image data, and a control unit, which is designed to control the controllable system based on the provided machine learning algorithm.

Thus, a system is indicated for controlling a controllable system based on a machine learning algorithm that is designed to determine at least one stixel in image data captured by an optical sensor and, for each of the at least one stixel, the respective distance to an object represented in the at least one stixel from the captured image data, wherein the machine learning algorithm was trained based on training data generated by an improved system for generating training data for training a machine learning algorithm, said machine learning algorithm being designed to determine at least one stixel in image data captured by an optical sensor and, for each of the at least one stixel, the respective distance to an object represented in the at least one stixel from the captured image data. In particular, a large number of stixels with corresponding distance information, or training data for training the machine learning algorithm, can be generated through relatively simple image processing operations and coordinate transformations, without the need for complex and resource-intensive adjustments or operations. In addition, the method can be realized with relatively simple sensors already installed in conventional motor vehicles. In addition, the generation of training data by the system for generating training data, which is based on a coordinate transformation of actually acquired data, is comparatively less prone to errors. In particular, coordinate transformations are applied when a problem is more easily solved in another coordinate system, whereby the corresponding distance value in the world coordinate system representing the base plane can be read or easily derived from the corresponding coordinates, for example, based on known norms.

In summary, the present invention specifies a method for generating training data for training a machine learning algorithm and, more particularly, to an improved method for generating training data for training a machine learning algorithm. This algorithm is designed to determine at least one stixel in image data captured by an optical sensor and, for each of the at least one stixel, a distance to an object represented in the at least one stixel from the captured image data.

The described embodiments and refinements may be combined with one another as desired.

Further possible designs, refinements and implementations of the invention also include combinations of features of the invention described previously or below with regard to the exemplary embodiments that are not explicitly mentioned.

### BRIEF DESCRIPTION OF THE DRAWINGS

The accompanying drawings are intended to provide a better understanding of the embodiments of the invention. They illustrate embodiments and, in connection with the description, serve to explain principles and concepts of the invention.

Other embodiments and many of the advantages mentioned are shown in the drawings. The illustrated elements of the drawings are not necessarily shown to scale with respect to one another.

The figures show:

FIG. 1 shows a flowchart of a method for generating training data for training a machine learning algorithm, said algorithm being designed to determine at least one stixel in image data captured by an optical sensor and, for each of the at least one stixel, the respective distance to an object represented in the at least one stixel from the captured image data according to embodiments of the invention;

FIG. 2 shows a schematic block diagram of a system for generating training data for training a machine learning algorithm, said algorithm being designed to determine at least one stixel in image data captured by an optical sensor and, for each of the at least one stixel, the respective distance to an object represented in the at least one stixel from the captured image data according to embodiments of the invention.

FIG. 3 shows a flowchart of a method for generating training data for training a machine learning algorithm, said algorithm being designed to determine at least one stixel in image data captured by an optical sensor and, for each of the at least one stixel, the respective distance to an object represented in the at least one stixel from the captured image data according to a first embodiment of the invention; and

FIG. 4 shows a flowchart of a method for generating training data for training a machine learning algorithm, said algorithm being designed to determine at least one stixel in image data captured by an optical sensor and, for each of the at least one stixel, the respective distance to an object represented in the at least one stixel from the captured image data according to a second embodiment of the invention.

In the figures of the drawings, identical reference numbers denote identical or functionally identical elements, parts or components, unless stated otherwise.

FIG. 1 shows a flowchart of a method for generating training data for training a machine learning algorithm, said algorithm being designed to determine 1 at least one stixel in image data captured by an optical sensor and, for each of the at least one stixel, the respective distance to an object represented in the at least one stixel from the captured image data according to embodiments of the invention.

Stixels have proven to be a compact and efficient way to process image data captured by an optical sensor, for example, a video camera of a motor vehicle, for further processing by downstream processes, such as driver assistance systems of a motor vehicle or functions of an autonomously driving motor vehicle.

A stixel is a superpixel representation of depth information in an image or image data in the form of a vertical stick or rod, which approximates the closest obstacles within a particular vertical portion of the scene.

Such stixels can be determined based on, for example, image data and motion algorithms. Additionally, machine learning algorithms are also known, which are designed or trained based on correspondingly labeled training data, to determine at least one stixel in image data captured by an optical sensor and, for each of the at least one stixel, the respective distance to an object represented in the at least one stixel from the captured image data. Advantageously, this method does not require a corresponding distance sensor, such as a lidar sensor, to determine the distance to the at least one stixel and the machine learning algorithm can also be used in motor vehicles equipped with only a camera and no corresponding distance sensor.

However, a disadvantage is that frequently only little training data is available for training a machine learning algorithm that is designed to determine at least one stixel in image data captured by an optical sensor and, for each of the at least one stixel, the respective distance to an object represented in the at least one stixel from the captured image data, and known methods for creating additional training data for training a machine learning algorithm, said machine learning algorithm being designed to determine at least one stixel in image data captured by an optical sensor and, for each of the at least one stixel, the respective distance to an object represented in the at least one stixel from the captured image data are frequently prone to errors.

FIG. 1 shows a method 1, which comprises a step 2 of generating image data, for example, of a motor vehicle's surroundings, wherein the image data is based on information detected by at least one optical sensor, wherein the at least one optical sensor comprises at least one distance sensor, a step 3 of ascertaining objects represented in the image data, a step 4 of generating at least one stixel from the image data based on the ascertained objects, a step 5 of ascertaining, for each of the at least one stixel, the distance to the object represented in the corresponding stixel on the basis of the image data and information detected using the at least one distance sensor, wherein the ascertainment of the distance includes a respective process of transforming coordinates in a coordinate system which represents one of the at least one distance sensors into coordinates in a coordinate system which represents a base plane.

Thus, a large number of stixels with corresponding distance information, or training data for training the machine learning algorithm, can be generated through relatively simple image processing operations and coordinate transformations, without the need for complex and resource-intensive adjustments or operations. Additionally, the method can be implemented using relatively simple sensors that are already installed in conventional motor vehicles.

Furthermore, method 1, which is based on coordinate transformation of actually captured data, is comparatively less prone to errors. In particular, coordinate transformations are applied when a problem is more easily solved in another coordinate system, whereby the corresponding distance value in the world coordinate system representing the base plane can be read or easily derived from the corresponding coordinates, for example, based on known norms.

Overall, this is thus an improved method 1 for generating training data for training a machine learning algorithm, said algorithm being designed to determine at least one stixel in image data captured by an optical sensor and, for each of the at least one stixel, the respective distance to an object represented in the at least one stixel from the captured image data.

The machine learning algorithm can be, for example, an artificial neural network.

According to the embodiments of FIG. 1, the at least one optical sensor further comprises a camera, wherein the image data is image data captured by the camera, and wherein the step 4 of generating at least one stixel comprises generating a segmentation of the image data.

In particular, individual stixels can be generated by first segmenting the image data, wherein, for each detected or ascertained object, its convex shell is then determined and filled in so that it appears as a continuous area, wherein the filling process can comprise filling up to a base or a base plane, and wherein the larger objects may be filled in first. The image data is then divided into columns, wherein a highest and lowest point, respectively a starting and an ending point, of the convex shell of the object appearing in the corresponding column primarily and/or closest to a viewer of the image data, are determined for each column. However, if such a highest and such a lowest point cannot be determined, the method may be discontinued for the corresponding column.

However, if no camera is present to capture image data, the image data may also be generated further based on data captured by other sensors, for example a distance sensor such as a lidar sensor, by applying an algorithm to the captured data designed to convert the captured sensor data into image data.

The segmentation may further be instance segmentation. This prevents a common convex shell for objects which are represented superimposed in the image data or immediately adjacent to each other.

According to the embodiments of FIG. 1, generating a segmentation of the image data also comprises applying a machine learning algorithm that is trained to segment image data.

The information detected by the at least one distance sensor further comprises, for each of the at least one stixel, information about at least one point on the object represented in the corresponding stixel, on which beams transmitted by the at least one distance sensor are reflected.

In particular, for each of the at least one stixel, based on the information detected by the at least one distance sensor, it may be checked whether the information comprises information about at least one point on the object represented in the corresponding stixel, which lies between the highest point and the lowest point of the convex shell of the object represented by the corresponding stixel on the corresponding convex shell. If such information cannot be determined, the method can in turn be discontinued for the respective stixel or the respective column.

According to the embodiments of FIG. 1, the information detected by the at least one distance sensor comprises information about a point on the object represented in the corresponding stixel, on which beams transmitted by the at least one distance sensor are reflected, and which has at least one predetermined height compared to the base surface.

In particular, based on the information about the at least one point on the object represented in the corresponding stixel, which lies between the highest point and the lowest point of the convex shell of the object represented in the corresponding stixel on the corresponding convex shell, that point is determined which has the shortest distance to the at least one distance sensor, and which at the same time has at least the predetermined height compared to the base surface.

Then, based on the point found or the corresponding information, by transforming corresponding coordinates in a coordinate system representing at least one distance sensor into coordinates in a coordinate system representing a base plane, the distance to the object represented in the corresponding stixel can be ascertained. If the object is an overhanging object, i.e. an object that projects rearward, or has a portion protruding outward, the ascertained distance can also be adjusted by applying a corresponding correction algorithm or overhang correction algorithm.

Thus, FIG. 1 describes a method that, in addition to at least one stixel, also generates information about a distance from the at least one distance sensor to an object represented in the at least one stixel.

The training data for training the machine learning algorithm is respectively based on the image data, a stixel generated therein, and the distance to the object represented in the corresponding stixel.

The training data can then be used for training a machine learning algorithm, said algorithm being designed to determine at least one stixel in image data captured by an optical sensor and, for each of the at least one stixel, the respective distance to an object represented in the at least one stixel from the captured image data.

The machine learning algorithm may be trained to control a controllable system based on corresponding labeled training data, for example, wherein the controllable system is, for example, a driver assistance system of a motor vehicle or a function of an autonomously driving motor vehicle, such as an adaptive speed control.

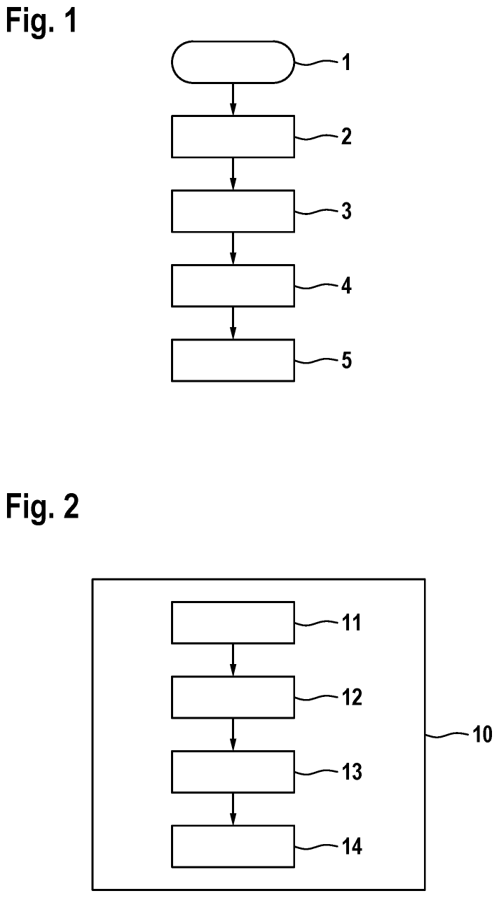

FIG. 2 shows a schematic block diagram of a system 10 for generating training data for training a machine learning algorithm, said algorithm being designed to determine at least one stixel in image data captured by an optical sensor and, for each of the at least one stixel, the respective distance to an object represented in the at least one stixel from the captured image data according to embodiments of the invention.

As FIG. 2 shows, the system thereby comprises a first generation unit 11, which is designed to generate image data, wherein the image data is based on information detected by at least one optical sensor, wherein the at least one optical sensor comprises at least one distance sensor, and wherein the system 10 further comprises a first ascertainment unit 12, which is designed to ascertain objects represented in the image data, a second generation unit 13, which is designed to generate at least one stixel from the image data based on the ascertained objects, and a second ascertainment unit 14, which is designed to ascertain, for each of the at least one stixel, a distance to the object represented in the corresponding stixel based on the image data and information detected by the at least one distance sensor, wherein ascertaining a distance includes a respective process of transforming coordinates in a coordinate system which represents one of the at least one distance sensors into coordinates in a coordinate system which represents a base plane, and wherein the training data is based on the respective image data, a stixel generated therein, and the distance to the object represented in the corresponding stixel.

The first generation unit can thereby comprise a receiver designed to receive corresponding sensor data, and which is further realized based on code stored in a memory and can be executed by a processor. The first ascertainment unit, the second generation unit and the second ascertainment unit can furthermore each be implemented on the basis of a code, for example, which is stored in a memory and can be executed by a processor.

According to the embodiments in FIG. 2, the at least one optical sensor further comprises a camera, wherein the image data is image data captured by the camera, and wherein the first generation unit 11 is designed to generate segmentation of the image data.

The first generation unit 11 is particularly designed to apply a machine learning algorithm trained to segment image data, in order to segment the image data.

According to the embodiments in FIG. 2, the information detected by the at least one distance sensor further comprises, for each of the at least one stixel, information about at least one point on the object represented in the corresponding stixel, on which beams transmitted by the lidar sensor are reflected.

In particular, the information detected by the at least one distance sensor further comprises information about a point on the object represented in the corresponding stixel, on which beams transmitted by the at least one distance sensor are reflected, and which has at least one predetermined height compared to the base surface.

For example, the at least one distance sensor may be a lidar sensor.

In addition, the illustrated system 10 is designed to execute a previously described method for generating training data for training a machine learning algorithm, said algorithm being designed to determine at least one stixel in image data captured by an optical sensor and, for each of the at least one stixel, the respective distance to an object represented in the at least one stixel.

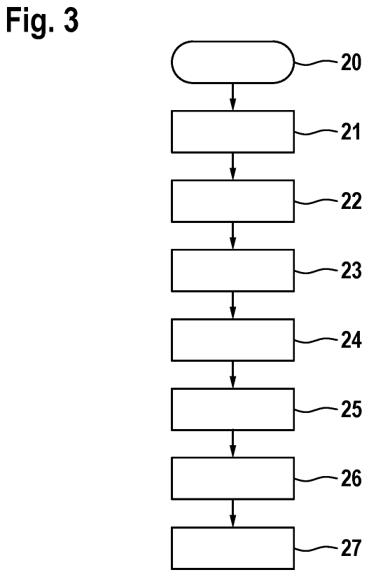

FIG. 3 shows a flowchart of a method for generating training data for training a machine learning algorithm, said algorithm being designed to determine 20 at least one stixel in image data captured by an optical sensor and, for each of the at least one stixel, the respective distance to an object represented in the at least one stixel from the captured image data according to a first embodiment of the invention.

In a step 21, sensor data is received, in particular image data from a camera and dense lidar data, or lidar data with a high acquisition density or a lidar point cloud with high density.

Then, in a step 22, lidar ground points representing a ground and points representing an object (L_obstacle) are determined based on the lidar point cloud, for example, by means of a plane fit algorithm.

In a step 23, the lidar ground points are then projected onto the camera image using camera and lidar extrinsic, camera intrinsic, and a corresponding projection model to obtain a depth image for the represented objects.

In a step 24, this depth image is then divided into fixed width rods or vertical sticks, respectively, wherein, in a step 25, corresponding ground points for each rod are determined within the corresponding rod.

Then, in a step 26, the point closest to the camera point, or the center of the camera parallel to the ground direction, is determined for each rod.

In a step 27, the ground point closest to that point is then determined within the corresponding rod, wherein, based on that ground point, the point closest to the ground point of the corresponding object representation and then the highest point of the corresponding object representation is determined.

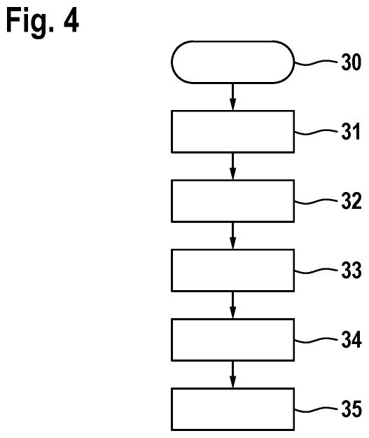

FIG. 4 shows a flowchart of a method for generating training data for training a machine learning algorithm, said algorithm being designed to determine 30 at least one stixel in image data captured by an optical sensor and, for each of the at least one stixel, the respective distance to an object represented in the at least one stixel from the captured image data according to a second embodiment of the invention.

In a step 31, sensor data is received, in particular a semantically segmented image of a camera and a sparse point cloud of a lidar sensor.

In a step 32, a convex shell is then calculated to extend the representation of the aboveground objects, for example vehicles, pedestrians, animals, or guardrails, to the ground.

In a step 33, the semantically segmented image is subsequently divided into fixed width rods or vertical sticks, wherein, in a step 34, for each rod, the lidar is projected onto the respective rod and the nearest 3D point is determined, which is within a range between a highest point and a lowest point of a respective object representation.

Next, in a step 35, the intersection point between the direction vector of the camera and the orthogonal to the ground plane is finally calculated to determine a more accurate lowest point of the object.

1. A method for generating training data for training a machine learning algorithm, the algorithm determines at least one stixel in image data captured by an optical sensor and, for each of the at least one stixel, the algorithm determines a respective distance to an object represented in the at least one stixel from the captured image data, the method comprising:
generating image data based on information captured by at least one optical sensor, the at least one optical sensor comprises at least one distance sensor;
ascertaining objects represented in the image data;
generating at least one stixel from the image data based on the ascertained objects; and
for each of the at least one stixel, ascertaining a distance to the object represented in a corresponding stixel based on the image data and information detected using the at least one distance sensor,
wherein ascertaining a distance includes a respective process of transforming coordinates in a coordinate system representing one of the at least one distance sensors into coordinates in a coordinate system representing a base plane, and
wherein the training data is based on respective image data, the corresponding stixel generated from the respective image data, and the distance to the object represented in the corresponding stixel.

2. The method according to claim 1, wherein:
the at least one optical sensor further comprises a camera, wherein the image data is image data captured by the camera, and
generating at least one stixel comprises generating a segmentation of the image data.

3. The method according to claim 2, wherein generating a segmentation of the image data comprises applying a machine learning algorithm trained to segment image data.

4. The method according to claim 1, wherein the information detected by the at least one distance sensor for each of the at least one stixel comprises information about at least one point on the object represented in the corresponding stixel, on which beams transmitted by the at least one distance sensor are reflected.

5. The method according to claim 4, wherein the information detected by the at least one distance sensor comprises information about a point on the object represented in the corresponding stixel, on which beams transmitted by the at least one distance sensor are reflected, and which has at least one predetermined height compared to a the base surface.

6. A method for training a machine learning algorithm, the algorithm determines at least one stixel in image data captured by an optical sensor and, for each of the at least one stixel, a respective distance to an object represented in the at least one stixel from the captured image data, the method comprising:
providing training data for training the machine learning algorithm, the training data generated by a method for generating training data for training a machine learning algorithm, the algorithm configured to determine at least one stixel in image data captured by an optical sensor and, for each of the at least one stixel, the respective distance to an object represented in the at least one stixel from the captured image data, which was generated according to claim 1; and
training the machine learning algorithm based on the provided training data.

7. A method for controlling a controllable system based on a machine learning algorithm, the algorithm determines at least one stixel in image data captured by an optical sensor and, for each of the at least one stixel, the respective distance to an object represented in the at least one stixel from the captured image data, the method comprising:
providing a machine learning algorithm to control the controllable system, the machine learning algorithm configured to determine at least one stixel in image data captured by an optical sensor and, for each of the at least one stixel, a respective distance to an object represented in the at least one stixel from the captured image data,
wherein the machine learning algorithm is trained according to claim 6 by a method for training a machine learning algorithm,
wherein the machine learning algorithm is to determine the at least one stixel in image data captured by the optical sensor and, for each of the at least one stixel, the respective distance to the object represented in the at least one stixel from the captured image data; and
wherein the controllable system is controled based on the machine learning algorithm.

8. A system for generating training data for training a machine learning algorithm that determines at least one stixel in image data captured by an optical sensor and, for each of the at least one stixel, a distance to an object represented in the at least one stixel from the captured image data, the system comprising:
a processor configured to:
generate image data based on information detected by at least one optical sensor, the at least one optical sensor comprises at least one distance sensor,
ascertain objects represented in the image data,
generate at least one stixel from the image data based on the ascertained objects,
ascertain, for each of the at least one stixel, a distance to the object represented in a corresponding stixel based on the image data and information detected by the at least one distance sensor,
wherein ascertaining a distance includes a respective process of transforming coordinates in a coordinate system which represents one of the at least one distance sensor into coordinates in a coordinate system which represents a base plane, and
wherein the training data is based on the respective image data, the corresponding stixel generated from the respective image data and the distance to the object represented in the corresponding stixel.

9. The system according to claim 8, wherein:
the at least one optical sensor further comprises a camera, the image data is image data captured by the camera, and the processor is further configured first to generate segmentation of the image data.

10. The system according to claim 9, wherein the processor is further configured to apply a machine learning algorithm trained to segment image data, in order to segment the image data.

11. The system according to claim 8, wherein the information detected by the at least one distance sensor for each of the at least one stixel comprises information about at least one point on the object represented in the corresponding stixel, on which beams transmitted by a lidar sensor are reflected.

12. The system according to claim 11, wherein the information detected by the at least one distance sensor comprises information about a point on the object represented in the corresponding stixel, on which beams transmitted by the at least one distance sensor are reflected, and which has at least one predetermined height compared to a base surface.

13. A system for training a machine learning algorithm that determines at least one stixel in image data captured by an optical sensor and, for each of the at least one stixel, a respective distance to an object represented in the at least one stixel from the captured image data, the system comprising:
a processor configured to:
provide training data for training the machine learning algorithm, the training data generated by a system for generating training data for training a machine learning algorithm according to claim 8, the machine learning algorithm configured to determine at least one stixel in image data captured by an optical sensor and, for each of the at least one stixel, the respective distance to the object represented in the at least one stixel from the captured image data, and
train the machine learning algorithm based on the provided training data.

14. A system for controlling a controllable system based on a machine learning algorithm that at least one stixel in image data captured by an optical sensor and, for each of the at least one stixel, a respective distance to an object represented in the at least one stixel from the captured image data, the system comprising:
a processor configured to:
provide a machine learning algorithm for controlling the controllable system, the machine learning algorithm configured to determine the at least one stixel in image data captured by the optical sensor and, for each of the at least one stixel, the respective distance to the object represented in the at least one stixel from the captured image data,
wherein the machine learning algorithm was trained by a method for training a machine learning algorithm according to claim 13,
wherein the machine learning algorithm is configured to determine at least one stixel in image data captured by an optical sensor and, for each of the at least one stixel, a respective distance to the object represented in the at least one stixel from the captured image data, and
wherein the processor is further configured to control the controllable system based on the provided machine learning algorithm.
